(19) United States
(12) Patent Application Publication
(10) Pub. No.: US 2004/0071470 A1
(43) Pub. Date: Apr. 15, 2004

(54) Free-space optics microroom

(75) Inventors: Brian W. Neff, Solana Beach, CA (US); Joseph J. Roy, Carlsbad, CA (US)

Correspondence Address: FITCH EVEN TABIN AND FLANNERY, 120 SOUTH LA SALLE STREET, SUITE 1600, CHICAGO, IL, 60603-3406, US

(73) Assignee: LightPointe Communications, Inc., San Diego, CA (US)

(21) Appl. No.: 10/268,210

(22) Filed: Oct. 9, 2002

(51) Int. Cl. H04B 10/00

(52) U.S. Cl. 398/129; 398/119

(57) ABSTRACT

The present invention provides an apparatus and method for free space optical communication. The apparatus and method provide a free-space optical communication. The apparatus can include a link head configured to provide optical communication, a microroom cover positioned about and encasing the link head and a flexure support. The flexure support is secured at a first end with the microroom cover and extends away from the microroom cover, and is further secured at a second end with a structure, wherein the flexure support is configured to flex from a first position when a force is applied to the microroom cover. The present invention optically aligns a first and second free-space optical communication apparatuses. When a force is received on the first communication apparatus a portion of the first apparatus tilts to maintain the optical alignment between the first and second communication apparatuses.

### BACKGROUND OF THE INVENTION

1. Field of the Invention

The present invention relates generally to free-space optical communication, and more specifically to protecting free-space optical network components to optimize communication.

2. Discussion of the Related Art

For digital data communications, optical media offers many advantages compared to wired and RF media. Large amounts of information can be encoded into optical signals, and the optical signals are not subject to many of the interference and noise problems that adversely influence wired electrical communications and RF broadcasts. Furthermore, optical techniques are theoretically capable of encoding up to three orders of magnitude more information than can be practically encoded onto wired electrical or broadcast RF communications, thus offering the advantage of carrying much more information.

Fiber optics are the most prevalent type of conductors used to carry optical signals. An enormous amount of information can be transmitted over fiber optic conductors. A major disadvantage of fiber optic conductors, however, is that they must be physically installed.

Free-space atmospheric links have also been employed to communicate information optically. A free-space link extends in a line of sight path between the optical transmitter and the optical receiver. Free-space optical links have the advantage of not requiring a physical installation of conductors. Free-space optical links also offer the advantage of higher selectivity in eliminating sources of interference, because the optical links can be focused directly between the optical transmitters and receivers, better than RF communications, which are broadcast with far less directionality. Therefore, any adverse influences not present in this direct, line-of-sight path or link will not interfere with optical signals communicated.

Despite their advantages, optical free-space links present problems. The quality and power of the optical signal transmitted depends significantly on the atmospheric conditions existing between the optical transmitter and optical receiver at the ends of the link.

It is with respect to these and other background information factors relevant to the field of optical communications that the present invention has evolved.

### SUMMARY OF THE INVENTION

The present invention advantageously addresses the needs above as well as other needs by providing a free-space optical communication apparatus. The apparatus can include a link head configured to provide optical communication, a microroom cover positioned about and encasing the link head and a flexure support. The flexure support is secured at a first end with the microroom cover and extends away from the microroom cover, and further secured at a second end with a structure, wherein the flexure support is configured to flex from a first position when a force is applied to the microroom cover.

In another embodiment, the invention provides an apparatus for protecting free-space communication network components. The apparatus for protecting includes a microroom cover and a flexure support. The flexure support has a first end and second end such that the first end of the flexure support is secured with the microroom cover and the second end of the flexure support is secured with a structure, wherein the flexure support is configured to flex when at least a predetermined force is applied to the microroom cover.

In another embodiment, the invention provides an apparatus for providing free-space optical communication. The apparatus includes a means for optically communicating, a means for protecting the means for optically communicating positioned about the means for optically communicating, and a means for maintaining optical alignment of the means for optically communicating. The means for maintaining optical alignment is configured to support the means for protecting, and flexes when a force is applied to the means for protecting.

In another embodiment, the invention provides a method of communicating optical signals over a free space link. The method includes the steps of optically aligning a first free-space optical communication apparatus with a second free-space optical communication apparatus; providing free-space optical communication between the first and second communication apparatuses; receiving a force on the first communication apparatus; allowing a portion of the first communication apparatus to tilt due to the force; and maintaining the optical alignment between the first and second communication apparatuses while the portion of the first communication apparatus tilts.

A better understanding of the features and advantages of the present invention will be obtained by reference to the following detailed description of the invention and accompanying drawings which set forth an illustrative embodiment in which the principles of the invention are utilized.

### BRIEF DESCRIPTION OF THE DRAWINGS

The above and other aspects, features and advantages of the present invention will be more apparent from the following more particular description thereof, presented in conjunction with the following drawings wherein:

FIG. 1 depicts a free-space optical communication network according to one embodiment of the present invention;

FIGS. 2 and 3 depict a simplified block diagram of a cross-sectional view and an elevated cross-sectional view, respectively, of an apparatus for free-space optical communication according to one embodiment of the present invention;

FIGS. 4-8 depict simplified block diagrams of elevated cross-sectional views of a flexure support and a link head support; and

FIG. 9 depicts a simplified block diagram of the free-space optical communication apparatus according to one embodiment of the present invention with a force being applied to at least the microroom cover;

FIGS. 10 and 11 depict a simplified block diagram cross-sectional view of an apparatus according to one embodiment where flexure support includes an accordion configuration or spring; and

FIGS. 12 and 13 depict a simplified block diagram cross-sectional view of a free-space optical communication apparatus according to two embodiments of the present invention.

Corresponding reference characters indicate corresponding components throughout the several views of the drawings.

### DETAILED DESCRIPTION

The following description is not to be taken in a limiting sense, but is made merely for the purpose of describing the general principles of the invention. The scope of the invention should be determined with reference to the claims.

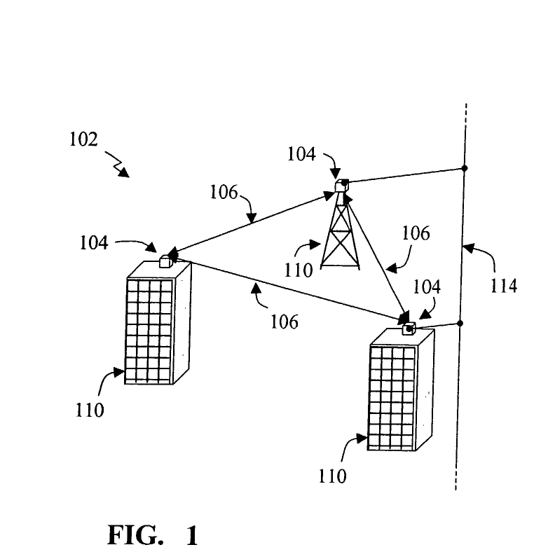

The present invention provides an apparatus and method to improve communication over free-space by providing protection to the optical communication network components. FIG. 1 depicts a free-space optical communication network 102 according to one embodiment of the present invention. The network includes a plurality of link heads 104. Each link head comprises a transmitter, a receiver or both a transmitter and receiver (i.e., a transceiver). A link head 104 is optically aligned with at least one other link head on opposite sides of free-space links 106. The link heads are mounted to structures 110, such as buildings, antennas, bridges, houses and other structures. The link heads can be coupled with a network 114, such as the Internet, an inter-campus network, a Public Switched Telephone Network (PSTN), cable television, cellular backhaul or other networks capable of communicating data and/or information.

These link heads 104 are precisely aligned in order to provide free-space communication across the links 106. Previous link heads were exposed to environmental conditions that could affect the optical alignment between to link heads, and thus reduce communication efficiency or prevent communication. A link head can be exposed to wind, hale, snow and other environmental conditions that can alter the link head positioning and/or alignment. For example, if a link head is exposed to wind of a sufficient force, the link head may shift, move, shake and/or oscillate away from an original position reducing or eliminating alignment. Additionally, hale can impact the link heads and knock them out of alignment. Similarly, other interfering factors can bump, jar or move a link head causing it to shift from alignment, such as birds landing on the link head, maintenance workers bumping into the link head and other similar interfering factors.

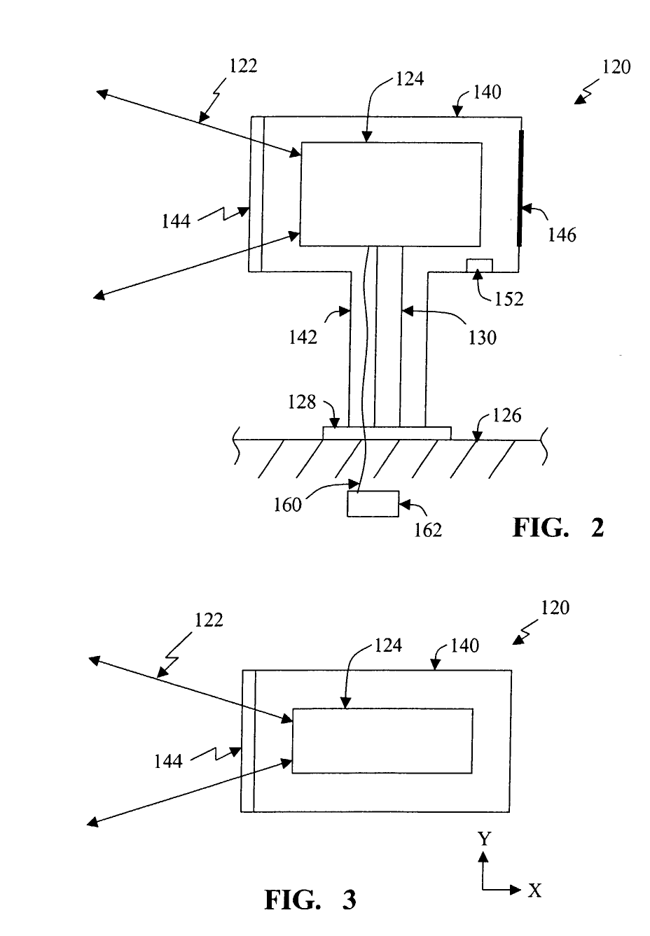

FIG. 2 depicts a simplified block diagram of a cross-sectional view of an apparatus 120 for free-space optical communication according to one embodiment of the present invention. FIG. 3 depicts a simplified block diagram of an elevated cross-sectional view of the apparatus 120. In some embodiments, the apparatus includes a link head 124. The link head can further include a transceiver for transmitting and receiving optical signals and/or beams 122. In other embodiments, the apparatus can include simply a transmitter for transmitting optical signals 122, or simply a receiver for receiving optical signals 122. The apparatus 120 can be mounted on a structure 126 such as a building, tower, antenna, bridge, house, pole, and other structures capable of supporting the apparatus.

A link head support 130 is typically utilized to mount, support and position the link head relative to the structure 126. In one embodiment, the link head support 130 is secured with the link head 124 at one end of the link head support, and at the other end of the link head support is secured to the structure 126. In one embodiment, the apparatus includes a base 128 that aids in mounting the link head 124 and link head support 130 with the structure 126. The link head support and/or base can be secured with the structure through substantially any means including, bolts, rivets, brackets, male-female connectors and substantially any other means for securing.

The apparatus 120 additionally includes a protection cover or microroom cover 140. Typically, the microroom cover surrounds and/or encases the link head 124. In one embodiment, the microroom cover seals in the link head to protect the link head from the atmosphere and environmental conditions and elements. The microroom cover can provide protection to the optical link head (and potentially its mount) from wind loading, and other forces that can affect the alignment of the link head, in addition to environmental protection from rain, snow, dust, and other conditions, to meet National Electronic Manufacturers Association (NEMA) standards, such as NEMA level 4 as well as other levels and/or other standards.

The microroom cover 140 includes at least one window or lens 144 that is optically aligned with the transmitter and/or receiver of the link head 124. As such, the transmitted and/or received optical signal(s) 122 passes through the window 144. Typically, the window is designed so that the optical signal is unaffected and unaltered by the window as it passes through the window 144. In one embodiment, the window provides filtering of ambient and/or stray light to further optimize communication. The window can be constructed of transparent glass, plastic, color filter glass, and substantially any other material or combination of materials and optical coatings to allow the optical signal 122 to pass through the window.

In one embodiment, the microroom cover 140 additionally includes a door or hatch 146 that provides a technician or other individual with access to the link head 124. In one embodiment, the door 146 is configured to be of a sufficient size to allow the microroom cover to be removed from about the link head allowing a technician easier access to the link head.

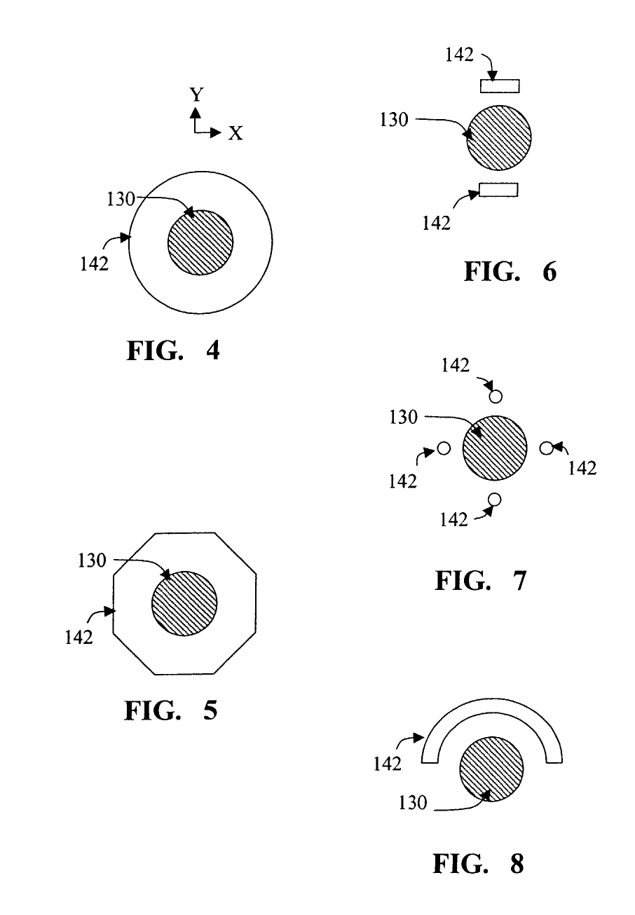

A flexure support 142 is secured to the microroom cover 140 at a first end of the flexure support, and to the structure 126 at a second end of the flexure support. In one embodiment, the flexure support is configured to surround and/or encase the link head support 130. However, the flexure support does not have to surround and/or encase the link head support. The flexure support can be configured provide support for the microroom cover and flex due to forces, as further described below. FIGS. 4-8 depict simplified block diagrams of elevated cross-sectional views of some examples of different embodiments of the link head support 130 and flexure support 142. The flexure support can be circular (see FIG. 4); octagonal (see FIG. 5); it can consist of a beam or a plurality of beams (see FIGS. 6 and 7) extending between the structure and the microroom cover; a semi-circular configuration (see FIG. 8); or substantially any other configurations.

The flexure support provides support for the microroom cover and positions the microroom cover relative to the link head 124 and the structure 126. In one embodiment, the flexure support is configured to have a footprint area that is small relative to the area of the microroom cover and typically small relative to an area of the link head. As such, the flexure support takes up only a minimal amount of structure real estate in positioning the microroom cover relative to the link head.

The microroom cover 140 can be detachably secured with the flexure support 142 to allow the microroom cover to be disengaged from the flexure support allowing the microroom cover to be removed from around the link head 124. Removal of the microroom cover allows for easier access to the link head and allows microroom covers to be replaced in the incident of damage to the cover or to clean and/or repair the microroom cover.

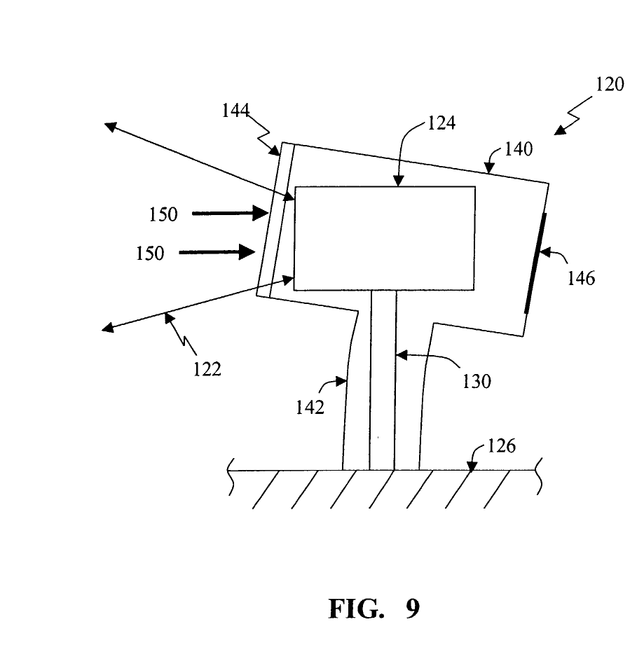

The flexure support 142 is configured to flex and/or bend from an original position when a force is applied to the microroom cover 140 and/or flexure support. FIG. 9 depicts a simplified block diagram of the apparatus 120 according to one embodiment of the present invention with a force 150 being applied to at least the microroom cover 140, such that the flexure support 142 is in a flexed or bent position. When a force 150 of sufficient strength is applied to the microroom cover 130, the flexure support 142 flexes from its original position carrying the load to the structure or base 126. The microroom cover 140 moves or tilts due to the flexing of the flexure support. However, the link head 124 is not affected by the force 150.

The microroom cover 140 and flexure support 142 protect the link head from the force to maintain optimum alignment of the link head with a second link head at an opposite end of a free-space communication link 106. Typically, the microroom cover 140 and flexure support 142 are configured to allow the microroom cover to move in both X and Y directions without interfering with the operation of the link head (see FIGS. 3 and 4). Because the flexure support carries the load of forces applied to the microroom cover, as appose to the link head 124 and link head support 130, the size and/or weight of the link head support can be reduced.

Again, the window 144 is configured to allow the optical signal 122 to pass without interfering or adversely affecting the signal. The window 144 is further configured to pass the optical signal 122 without adverse affects even as the microroom cover 140 moves, shifts or tilts from an original position due to the applied force(s) 150. As such, tilting of the window does not affect the link head alignment. Even though the window is not square with the link head, the optical signal still passes through the window maintaining a communication link between two link heads.

The microroom cover 140 can be constructed of substantially any material or combination of materials capable of withstanding the expected forces 150 including plastic, fiberglass, aluminum, tin, steal, PVC, and substantially any other material or combination of materials that can protect the link head from the force(s) 150. In some embodiments, the microroom cover additionally protects the link head and/or associated electronics, optical, electrical and/or power cables 160 from the environment. As such, the microroom cover seals the link head to prevent moisture, dust, sand, pollutants, insects and other things that can adversely affect the link head, electronics, wiring and the optical communication. Additionally, the microroom cover 140 can limit the amount of electro magnetic interference (EMI) emitted by the link head 140 or external EMI that may interfere with the operation of the link head (e.g., utilizing aluminum in the construction of the link head).

Similarly, the flexure support 142 can be constructed of substantially any material or combination of materials including plastic, fiberglass, aluminum, tin, steal, PVC, and substantially any other material capable of withstanding the expected forces 150 while remaining rigid or flexing from an original position without damaging the flexure support and microroom cover, and without interfering with the operation and alignment of the link head 124. Additionally, the flexure support can be configured to aid in sealing the link head to protect the link head and/or associated electronics and wiring from the environment.

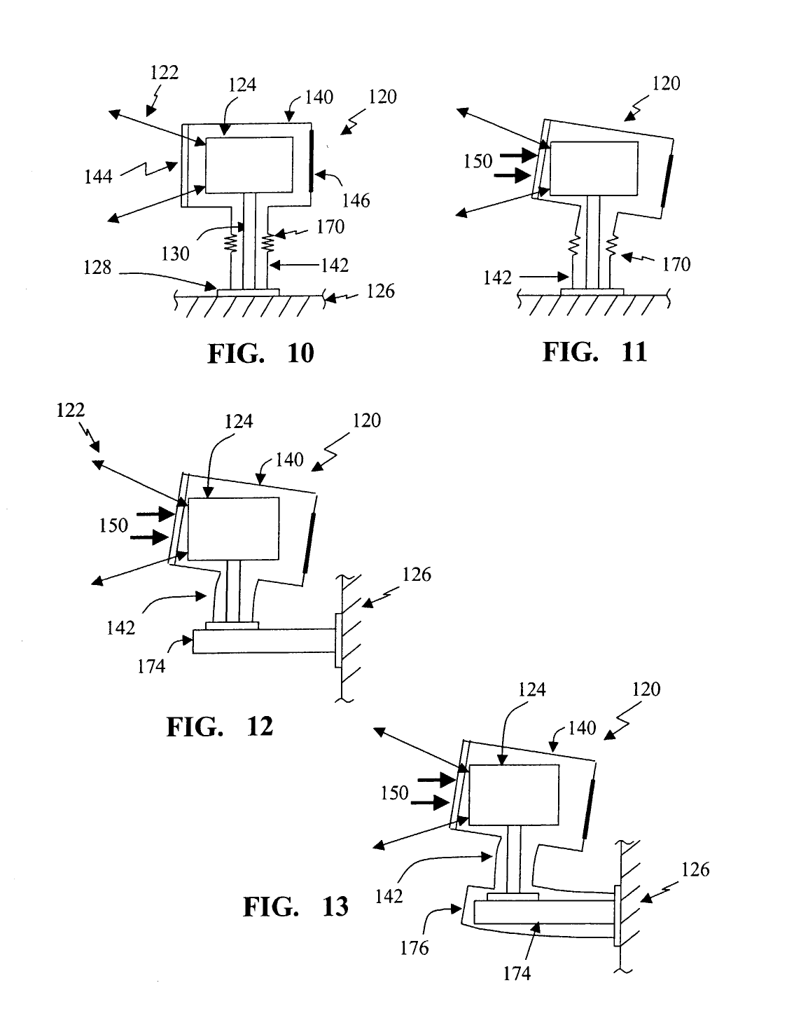

The flexure support 142 can include other configurations allowing the support to flex, including an undulating accordion or corrugated configuration 170, an accordion or corrugated portion within or at one or both ends of the support, a spring coil configuration extending between the structure 126 and the microroom cover 140, one or more springs positioned within the length of or at one or both ends of the support(s) and other similar configurations or combinations of configurations providing support for the microroom cover and the flexibility to compensate for forces applied to the apparatus 120. FIGS. 10 and 11 depict a simplified block diagram cross-sectional view of an apparatus 120 according to one embodiment where the flexure support 142 includes an accordion configuration or spring 170.

In one embodiment, the microroom cover can include an internal environment control system 152. The internal environment control system can include a defroster to prevent frosting of the window, for example when the due point falls. The internal environmental control system can additionally include a temperature control system, such as a fan, heating element(s) or other components to maintain the temperature of the link head within a predefined optimal temperature range, and substantially any other internal environmental control. The internal environmental control system can include other conditional controls, such as a deicer, dehumidifier and other such environmental controls.

The microroom cover 140 and/or flexure support can be configured to provide protection for substantially any link head 124 and for substantially any mounting. FIGS. 12 and 13 depict a simplified block diagram cross-sectional view of a free-space optical communication apparatus 120 according to two embodiments of the present invention. In one embodiment, the link head 124 can be mounted with a structure through a cantilever or angle bracket 174 while the microroom 140 is positioned about the link head. The flexure supports 142 can extend from the link head to the cantilever support or can extend to a cantilever flexure support 176 that extends from the structure 126 proximate the cantilever support 174 supporting the link head 124. It will be apparent to one skilled in the art that other mounting configurations can be employed while still maintaining the protection provided by the microroom without departing from the inventive aspects of the present invention.

Because the link head is protected from adverse forces, the strength and size of the link head 124 and/or support 130 can be reduced. This reduction results in decreased costs of the link head and allows for easier installation. Additionally, the link head can be configured such that electronics 162 are housed remote from the link head, for example in the base or within the structure 126. This reduces the link head size and allows additional environmental control. Further, the reduced link head size can allow the size of the microroom cover to be reduced.

The environment poses many problems for free-space optical communication hardware including wind buffeting that affects optical pointing and/or alignment stability. The microroom cover isolates the optical link head from these effects by, in part, transfer wind loads and other forces that can adversely affect the alignment of the link head to the mount base and/or structure and thus away from the optical head. Rain, snow windblown particles, and solar loading can also affect the optical performance of free-space optical systems. In some embodiment, the microroom cover provides a weather tight enclosure that protects the free-space optical communication hardware from these and other types of environmental conditions. Further, in some embodiments heat can be added or removed passively or actively to maintain the hardware within optimal operating temperature ranges.

While the invention herein disclosed has been described by means of specific embodiments and applications thereof, numerous modifications and variations could be made thereto by those skilled in the art without departing from the scope of the invention set forth in the claims.

What is claimed is:

1. A free-space optical communication apparatus, comprising:
a link head configured to provide optical communication;
a microroom cover positioned about and encasing the link head; and
a flexure support secured at a first end with the microroom cover and extending away from the microroom cover, and further secured at a second end with a structure.

2. The apparatus as claimed in claim 1, wherein the microroom cover is configured to provide environmental protection for the link head.

3. The apparatus as claimed in claim 2, wherein the microroom cover protects the link head from heat, cold, sun light, contaminates, precipitation and condensation.

4. The apparatus as claimed in claim 1, wherein the flexure support is configured to flex from a first position when a force is applied to the microroom cover.

5. The apparatus as claimed in claim 1, wherein the flexure support is configured to flex such that the microroom cover tilts without affecting an optical alignment of the link head.

6. The apparatus as claimed in claim 1, further comprising:
a link head support secured with the link head at a first end of the link head support, such that the link head support extends away from the link head, and a second end of the link head support being secured with the structure, wherein the link head support is enclosed within the flexure support.

7. The apparatus as claimed in claim 1, wherein the microroom cover includes a window positioned such that free-space optical signals pass through the window.

8. The apparatus as claimed in claim 7, wherein the window is further configured to allow free-space optical signals to pass when the flexure support is in the first position and when the flexure support is flexed from the first position.

9. The apparatus as claimed in claim 1, wherein the flexure support has a base footprint that has a footprint area that is less than an area defined by an area of the link head.

10. An apparatus for protecting free-space communication network components, comprising:
a microroom cover; and
a flexure support having a first end and second end, such that the first end of the flexure support is secured with the microroom cover and the second end of the flexure support is secured with a structure, wherein the flexure support is configured to flex when at least a predetermined force is applied to the microroom cover.

11. The apparatus as claimed in claim 10, wherein the microroom cover includes an optical window through which free-space optical signals pass.

12. The apparatus as claimed in claim 11, wherein the microroom cover includes a door to allow access within the microroom cover.

13. The apparatus as claimed in claim 12, wherein the microroom cover is configured to be positioned about a link head.

14. The apparatus as claimed in claim 13, wherein the flexure support is configured to flex causing the microroom cover to shift without interfering with an alignment of the link head.

15. An apparatus for providing free-space optical communication, comprising:
a means for optically communicating over free-space;
a means for protecting the means for optically communicating positioned about the means for optically communicating; and
a means for maintaining optical alignment of the means for optically communicating, wherein means for maintaining optical alignment supports the means for protecting and flexes when a force is applied to the means for protecting.

16. The apparatus as claimed in claim 15, wherein a position of the means for protecting shifts when the means for maintaining optical alignment flexes without interfering with the means for optically communicating.

17. The apparatus as claimed in claim 16, wherein the means for protecting includes a means for passing optical signals.

18. A method of communicating optical signals over free-space, comprising the steps of:
positioning a free-space optical communication apparatus;
aligning an optical transceiver in the free-space optical communication apparatus with a free-space link;
receiving a force on the free-space optical communication apparatus; and
maintaining optical alignment of the optical transceiver in the free-space optical communication apparatus with the free-space link when the force is applied to the free-space optical communication apparatus.

19. The method as claimed in claim 18, wherein the step of maintaining includes the step of compensating for the force to maintain alignment.

20. The method as claimed in claim 18, wherein the step of maintaining includes the steps of allowing a first portion of the free-space optical communication apparatus to tilt due to the force.

21. The method as claimed in claim 20, wherein the step of maintaining includes the steps of flexing a second portion of the free-space optical communication apparatus causing the first portion to tilt.

22. A method of communicating over free-space, comprising the steps of:
positioning a free-space link head;
setting a direction of communication of the link head; and
preventing environmental conditions from disrupting the direction of communication.

23. The method as claimed in claim 22, wherein the step of preventing includes the steps of encasing the link head, and compensating for environmental forces by allowing a portion of an encasing to flex due to the forces without disrupting the direction of communication of the link head.

24. The method as claimed in claim 23, further comprising the step of preventing external forces from disrupting the direction of communication.
